(19) United States
(12) Patent Application Publication
(10) Pub. No.: US 2007/0148322 A1
(43) Pub. Date: Jun. 28, 2007

(54) Southern homestyle traditional potato salad deluxe

(76) Inventor: Regina Y. Green, Camden, AR (US)

Correspondence Address: JAMES RAY & ASSOCIATES, 2640 PITCAIRN ROAD, MONROEVILLE, PA, 15146, US

(21) Appl. No.: 11/590,462

(22) Filed: Oct. 31, 2006

Related U.S. Application Data
(60) Provisional application No. 60/754,333, filed on Dec. 28, 2005.

(51) Int. Cl. A23L 1/216

(52) U.S. Cl. 426/637

(57) ABSTRACT

A base homestyle potato salad blend for one of being used by itself and for use in conjunction with other additives for adding to fresh boiled eggs and potatoes to make potato salad. The base homestyle potato salad blend comprises mayonnaise and sandwich spread each being present in the homestyle potato salad blend in a concentration of between about 26 and about 30 percent by weight. Sweet pickle relish is present in the homestyle potato salad blend in a concentration of between about 12 and about 16 percent by weight. Mustard, pimento and granulated sugar are each present the homestyle potato salad blend in a concentration of between about 6 and about 8.5 percent by weight. Vinegar is present in the blend in a concentration of between about 2.5 and about 4.5 percent by weight. Salt is present in the blend in a concentration of between about 1 and about 2.5 percent by weight; and pepper is present in the potato salad blend in a concentration of between about 0.5 and about 1.5 percent by weight.

### CROSS REFERENCE TO RELATED APPLICATIONS

This application is closely related to and claims benefit from U.S. Provisional Application Ser. No. 60/754,333 filed Dec. 28, 2005.

### FIELD OF THE INVENTION

The present invention relates, in general, to a recipe for potato salad, and, more particularly, the present invention relates to a base dressing mixture which can be used to prepare a traditional homestyle potato salad.

### BACKGROUND OF THE INVENTION

Traditionally, preparing homemade potato salad is a labor of love for homestyle cooking. Dicing, measuring, mixing and creating the entire recipe from scratch is very time consuming. Trial and error often plays a role in making a meal of flavorful delight. Too much of any one ingredient can overpower and ruin the flavor of the potato salad. Too little of any one ingredient can lead to a bland potato salad taste. Cooks do not want to be remembered for an ill tasting potato salad. With all the work that is involved in preparing the potato salad the cook would like the potato salad to be appreciated when it is eaten by the family or guests.

Thus, it would be advantageous if there were a dressing mixture that were available to which the cook could simply add fresh boiled eggs and potatoes that would always create a wonderful tasting potato salad.

### SUMMARY OF THE INVENTION

In a first aspect the present invention provides a base homestyle potato salad blend for one of being used by itself and for use in conjunction with other additives for adding to fresh boiled eggs and potatoes to make potato salad. The base homestyle potato salad blend comprises mayonnaise and sandwich spread each being present in the homestyle potato salad blend in a concentration of between about 26 and about 30 percent by weight. Sweet pickle relish is present in the homestyle potato salad blend in a concentration of between about 12 and about 16 percent by weight. Mustard, pimento and granulated sugar are each present the homestyle potato salad blend in a concentration of between about 6 and about 8.5 percent by weight. Vinegar is present in the blend in a concentration of between about 2.5 and about 4.5 percent by weight. Salt is present in the blend in a concentration of between about 1 and about 2.5 percent by weight; and pepper is present in the potato salad blend in a concentration of between about 0.5 and about 1.5 percent by weight.

### OBJECTS OF THE INVENTION

It is, therefore, one of the primary objects of the present invention is to provide a base homestyle potato salad blend that can be added to fresh boiled eggs and potatoes to create a complete potato salad.

Another object of the present invention is to provide a base homestyle potato salad blend to which other ingredients such as onions, green onions, celery and bell peppers can be added either individually or together.

Still another object of the present invention is to provide a base homestyle potato salad blend which can also be used with macaroni to create a macaroni salad.

Yet another object of the present invention is to provide a base homestyle potato salad blend which can be made into a prepackaged dressing blend.

These and various other objects and advantages of this invention will become apparent after a full reading of the following detailed description, particularly, when read in conjunction with the attached drawings as described below and the appended claims.

### BRIEF DESCRIPTION OF THE PRESENTLY PREFERRED AND ALTERNATE EMBODIMENTS OF THE INVENTION

In a first aspect the present invention provides a base homestyle potato salad blend for one of being used by itself and for use in conjunction with other additives for adding to fresh boiled eggs and potatoes to make potato salad. The base homestyle potato salad blend comprises mayonnaise and sandwich spread each being present in the homestyle potato salad blend in a concentration of between about 26 and about 30 percent by weight. Sweet pickle relish is present in the homestyle potato salad blend in a concentration of between about 12 and about 16 percent by weight. Mustard, pimento and granulated sugar are each present the homestyle potato salad blend in a concentration of between about 6 and about 8.5 percent by weight. Vinegar is present in the blend in a concentration of between about 2.5 and about 4.5 percent by weight. Salt is present in the blend in a concentration of between about 1 and about 2.5 percent by weight; and pepper is present in the potato salad blend in a concentration of between about 0.5 and about 1.5 percent by weight.

It should be noted that all of the above ingredients are commercially available at local supermarkets. Items such as mayonnaise and sandwich spread are marketed by Kraft Foods and by Hellmans among others. The other items are also all available from various manufactures.

In a more preferred embodiment of the invention such mayonnaise and such sandwich spread are each present in the base homestyle potato salad blend in a concentration of between about 28 and about 29.5 percent by weight and wherein the pickle relish is present in base homestyle potato salad blend in a concentration of between about 13.5 and about 15 percent by weight.

In the more preferred embodiment mustard, pimento and sugar are each present in base homestyle potato salad blend in a concentration of between about 6.5 and about 7.8 percent by weight.

The above represents the simple base blend that can be used to create a flavorful potato or macaroni salad without all the work involved in preparation. The dressing can be as described above or it can be made to contain a variety of flavors that would be based on consumer tastes. The base blend could also contain chopped onions, chopped green onions, chopped celery and chopped bell peppers. As stated previously the base blend could be modified with any of these flavors individually or all of these flavors together to form a deluxe blend. Such basic base blend could also be made to contain various combinations of these additional flavorings. These additional flavorings are added in predetermined amounts.

Again as stated previously, such base homestyle potato salad blend further includes any one of chopped onions, chopped green onions, chopped celery and chopped bell peppers wherein any one of these flavorings would be present in the homestyle potato salad blend in a concentration of between about 5.5 and about 8 percent by weight and the homestyle potato salad blend being present in the new mixture in a concentration of between about 92 and 94.5 percent by weight.

The base blend could also be modified by the addition of any two of the listed flavorings as desired. When two additional ingredients are added to the base blend each of the additional ingredients are present in the new blend in a concentration of between about 5.5 and about 7 percent by weight and the base homestyle potato salad blend is present in the new mixture in a concentration of between about 86 and 89 percent by weight.

In the case where three of these flavorings (again it can be any three depending on the desired flavor) are added to the base blend each of the additional flavorings are present in the new blend in a concentration of between about 5 and about 6.5 percent by weight and the base homestyle potato salad blend is present in the new blend in a concentration of between about 81.5 and 85 percent by weight.

In the case where all four of the flavorings (onions, green onions, celery and bell peppers) are added to the base blend each of the four additional flavorings are present in the new homestyle potato salad blend in a concentration of between about 4.6 and about 6.2 percent by weight and the base homestyle potato salad blend is present in a concentration of between about 75.2 and 81.6 percent by weight.

Thus, all the consumer has to do is simply add fresh boiled eggs (sliced or quartered as desired) and potatoes (generally diced) to the desired base. Once the base, potatoes and eggs are combined the consumer can simply chill or refrigerate the dish and then serve. As mentioned previously it is within the concept of the invention that such basic base homestyle potato salad blend or the combination blends as described above can also be used to combine with macaroni and eggs to make a delightful macaroni salad.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. A base homestyle potato salad blend for one of being used by itself and for use in conjunction with other additives for adding to fresh boiled eggs and potatoes, said base homestyle potato salad blend comprising:
(a) mayonnaise being present in said homestyle potato salad blend in a concentration of between about 26 and about 30 percent by weight;
(b) sandwich spread being present in said homestyle potato salad blend in a concentration of between about 26 and about 30 percent by weight;
(c) sweet pickle relish being present in said homestyle potato salad blend in a concentration of between about 12 and about 16 percent by weight;
(d) mustard being present in said homestyle potato salad blend in a concentration of between about 6 and about 8 percent by weight;
(e) pimento being present in said homestyle potato salad blend in a concentration of between about 6 and about 8.5 percent by weight;
(f) granulated sugar being present in said homestyle potato salad blend in a concentration of between about 6 and about 8.5 percent by weight;
(g) vinegar being present in said homestyle potato salad blend in a concentration of between about 2.5 and about 4.5 percent by weight
(h) salt being present in said homestyle potato salad blend in a concentration of between about 1 and about 2.5 percent by weight; and
(i) pepper being present in said homestyle potato salad blend in a concentration of between about 0.5 and about 1.5 percent by weight.

2. The base homestyle potato salad blend, according to claim 1, wherein said mayonnaise and said sandwich spread are each present in said base homestyle potato salad blend in a concentration of between about 28 and about 29.5 percent by weight.

3. The base homestyle potato salad blend, according to claim 1, wherein said pickle relish is present in said base homestyle potato salad blend in a concentration of between about 13.5 and about 15 percent by weight.

4. The base homestyle potato salad blend, according to claim 1, wherein said mustard, said pimento and said sugar are each present in said base homestyle potato salad blend in a concentration of between about 6.5 and about 7.8 percent by weight.

5. The base homestyle potato salad blend, according to claim 1, wherein said base homestyle potato salad blend further includes one of chopped onions, chopped green onions, chopped celery and chopped bell peppers wherein said one of chopped onions, chopped green onions, chopped celery and chopped bell peppers are present in said homestyle potato salad blend in a concentration of between about 5.5 and about 8 percent by weight and said homestyle potato salad blend is present in a concentration of between about 92 and 94.5 percent by weight.

6. The base homestyle potato salad blend, according to claim 1, wherein said base homestyle potato salad blend further includes chopped onions and chopped green onions, wherein said each of chopped onions and chopped green onions being present in is said homestyle potato salad in a concentration of between about 5.5 and about 7 percent by weight and said homestyle potato salad blend is present in a concentration of between about 86 and 89 percent by weight.

7. The base homestyle potato salad blend, according to claim 1, wherein said base homestyle potato salad blend further includes chopped onions and chopped celery, wherein said each of chopped onions and chopped celery being present in said homestyle potato salad in a concentration of between about 5.5 and about 7 percent by weight and said homestyle potato salad blend is present in a concentration of between about 86 and 89 percent by weight.

8. The base homestyle potato salad blend, according to claim 1, wherein said base homestyle potato salad blend further includes chopped onions and chopped bell peppers, wherein said each of chopped onions and chopped bell peppers being present in said homestyle potato salad in a concentration of between about 5.5 and about 7 percent by weight and said homestyle potato salad blend is present in a concentration of between about 86 and 89 percent by weight.

9. The base homestyle potato salad blend, according to claim 1, wherein said base homestyle potato salad blend further includes chopped green onions and chopped celery, wherein said each of chopped green onions and chopped celery being present in said homestyle potato salad in a concentration of between about 5.5 and about 7 percent by weight and said homestyle potato salad blend is present in a concentration of between about 86 and 89 percent by weight.

10. The base homestyle potato salad blend, according to claim 1, wherein said base homestyle potato salad blend further includes chopped green onions and chopped bell peppers, wherein said each of chopped green onions and chopped bell peppers being present in said homestyle potato salad in a concentration of between about 5.5 and about 7 percent by weight and said homestyle potato salad blend is present in a concentration of between about 86 and 89 percent by weight.

11. The base homestyle potato salad blend, according to claim 1, wherein said base homestyle potato salad blend further includes chopped celery and chopped bell peppers, wherein said each of chopped celery and chopped bell peppers being present in said homestyle potato salad in a concentration of between about 5.5 and about 7 percent by weight and said homestyle potato salad blend is present in a concentration of between about 86 and 89 percent by weight.

12. The base homestyle potato salad blend, according to claim 1, wherein said base homestyle potato salad blend further includes chopped onions, chopped green onions and chopped celery, wherein said each of chopped onions, chopped green onions and chopped celery being present in said homestyle potato salad in a concentration of between about 5 and about 6.5 percent by weight and said homestyle potato salad blend is present in a concentration of between about 81.5 and 85 percent by weight.

13. The base homestyle potato salad blend, according to claim 1, wherein said base homestyle potato salad blend further includes chopped onions, chopped green onions and chopped bell peppers, wherein said each of chopped onions, chopped green onions and chopped bell peppers being present in said homestyle potato salad in a concentration of between about 5 and about 6.5 percent by weight and said homestyle potato salad blend is present in a concentration of between about 81.5 and 85 percent by weight.

14. The base homestyle potato salad blend, according to claim 1, wherein said base homestyle potato salad blend further includes chopped green onions, chopped celery and chopped bell peppers, said each of chopped green onions, chopped celery and chopped bell peppers being present in said homestyle potato salad in a concentration of between about 5 and about 6.5 percent by weight and said homestyle potato salad blend is present in a concentration of between about 81.5 and 85 percent by weight.

15. The base homestyle potato salad blend, according to claim 1, wherein said base homestyle potato salad blend further includes chopped onions, chopped green onions, chopped celery and chopped bell peppers wherein each of said chopped onions, chopped green onions, chopped celery and chopped bell peppers are present in said base homestyle potato salad blend in a concentration of between about 4.6 and about 6.2 percent by weight and said homestyle potato salad blend is present in a concentration of between about 75.2 and 81.6 percent by weight.
